(19) United States
(12) Patent Application Publication
(10) Pub. No.: US 2024/0360981 A1
(43) Pub. Date: Oct. 31, 2024

(54) NEON PATTERN LAMP WITH MULTI-COLOR DYNAMIC LIGHTING EFFECT

(71) Applicant: Mingxuan Luo, Hanshou (CN)

(72) Inventor: Mingxuan Luo, Hanshou (CN)

(21) Appl. No.: 18/769,405

(22) Filed: Jul. 11, 2024

(51) Int. Cl. F21V 11/16; F21V 3/02; F21Y 113/13

(52) U.S. Cl. CPC F21V 11/16; F21V 3/02; F21Y 2113/13

(57) ABSTRACT

The present disclosure relates to the technical field of neon pattern lamps, and in particular, to a neon pattern lamp with a multi-color dynamic lighting effect. The neon pattern lamp includes a bottom plate and a neon lamp tube; the entire bottom plate is tree-shaped; and the neon lamp tube is arranged at an upper end of the bottom plate. The present disclosure is a low-cost and high-benefit unique solution for converting a 2D effect into a 3D effect. The most vivid visual experience effect can be expressed using the simplest light and shadow changes, so that the 2D neon pattern lamp can interact with people in the real world, instead of only having a monotonous showing function, and can achieve or replace the light and shadow lighting effects of some physical objects.

### TECHNICAL FIELD

The present disclosure relates to the technical field of neon pattern lamps, and in particular, to a neon pattern lamp with a multi-color dynamic lighting effect.

### BACKGROUND

An existing 2-dimensional (2D) neon pattern lamp have three lighting effects: a fully static lighting effect, a dynamic and static mixed lighting effect, and a fully dynamic lighting effect. There are currently two dynamic and static mixed lighting schemes: partial static lighting and partial colorful dynamic lighting, and partial static lighting and partial loop dynamic lighting. The dynamic lighting effect on the same neon pattern lamp accounts for about 20% to 80%. The dynamic lighting effect affects the static lighting effect more or less.

### SUMMARY

The present disclosure aims to provide a neon pattern lamp with a multi-color dynamic lighting effect, so as to solve the problems in the above background section.

A neon pattern lamp with a multi-color dynamic lighting effect includes a bottom plate and a neon lamp tube; the entire bottom plate is tree-shaped; and the neon lamp tube is arranged at an upper end of the bottom plate.

Preferably, the neon lamp tube has static lighting.

A desired shape is formed on the surface of the bottom plate through the neon lamp tube, and the neon lamp tube has the static lighting, so that the neon lamp tube can reflect the desired shape.

Preferably, eye sheets are arranged in a center of a surface of the bottom plate, and the eye sheets are composed of white paper.

Eyes are formed by the eye sheets, so that the device is more vivid and specific.

Preferably, fixed strips are arranged on side surfaces of the eye sheets; and lamp bodies are arranged on side surfaces of the fixed strips at equal distances.

There are several lamp bodies which emit different colors of light. Different colors are switched through the lamp bodies, so that the eye sheets can show different colors, and the device is more specific. The white eye sheets allow the light to easily pass through.

Beneficial effects of the present disclosure are as follows:
1. The device only has a dynamic lighting effect at the positions of the eye sheets, and the dynamic lighting effect accounts for only 1% to 5%. In the same neon pattern lamp, the dynamic lighting effect is at a key dynamic lighting effect position. A static lighting effect cannot be affected, and will be further highlighted, so that an overall 2D pattern can show a 3D pattern effect.

The dynamic lighting effect at the eyes of the 2D neon pattern lamp is completely distinguished from the dynamic and static lighting effect of the current 2D neon pattern lamp on the market. The present disclosure is a low-cost and high-benefit unique solution for converting a 2D effect into a 3D effect. The most vivid visual experience effect can be expressed using the simplest light and shadow changes, so that the 2D neon pattern lamp can interact with people in the real world, instead of only having a monotonous showing function, and can achieve or replace the light and shadow lighting effects of some physical objects.

### BRIEF DESCRIPTION OF THE DRAWINGS

The accompanying drawings are intended to provide a further understanding of the present disclosure and constitute a part of this specification. The accompanying drawings and the embodiments of the present disclosure are used together for explaining the present disclosure rather than constituting a limitation on the present disclosure. In the drawings:

FIG. 1 is a schematic diagram of an entire three-dimensional structure of the present disclosure; and

FIG. 2 is a schematic structural diagram of mounting of a fixed strip and lamp bodies of the present disclosure.

In the drawings: 1: bottom plate; 2: neon lamp tube; 3: eye sheet; 4: fixed strip; and 5: clamp body.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

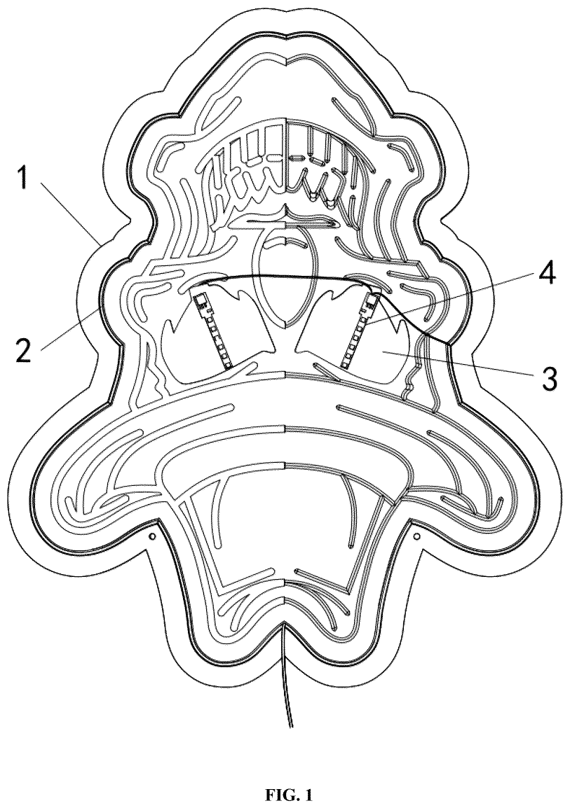

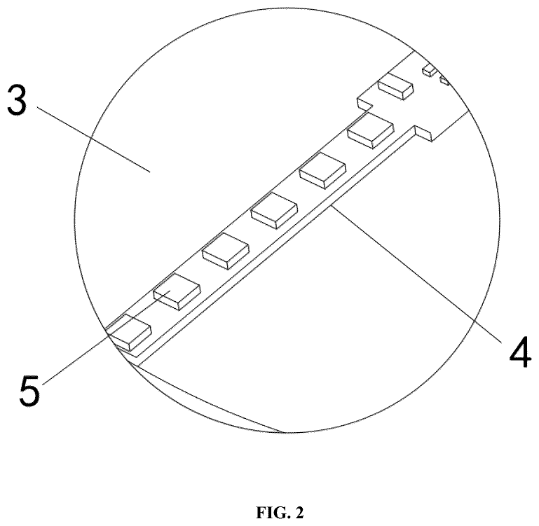

In specific implementation, as shown in FIG. 1 and FIG. 2, a neon pattern lamp with a multi-color dynamic lighting effect includes a bottom plate 1 and a neon lamp tube 2; the entire bottom plate 1 is tree-shaped; and the neon lamp tube 2 is arranged at an upper end of the bottom plate 1.

The neon lamp tube 2 has static lighting.

A desired shape is formed on the surface of the bottom plate 1 through the neon lamp tube 2, and the neon lamp tube 2 has the static lighting, so that the neon lamp tube 2 can reflect the desired shape.

Eye sheets 3 are arranged in a center of a surface of the bottom plate 1, and the eye sheets 3 are composed of white paper.

Eyes are formed by the eye sheets 3, so that the device is more vivid and specific.

Fixed strips 4 are arranged on side surfaces of the eye sheets 3; and lamp bodies 5 are arranged on side surfaces of the fixed strips 4 at equal distances.

There are several lamp bodies 5 which emit different colors of light. Different colors are switched through the lamp bodies 5, so that the eye sheets 3 can show different colors, and the device is more specific. The white eye sheets 3 allow the light to easily pass through.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

It should be finally noted that: The foregoing embodiments are merely preferred embodiments of the present disclosure, but not intended to limit the present disclosure. Although the present disclosure is described in detail with reference to the foregoing embodiments, a person of ordinary skill in the art may still make modifications to the technical solutions described in the foregoing respective embodiments or make equivalent replacements to partial technical features thereof. Any modification, equivalent replacement, and improvement made within the spirit and scope of the present disclosure shall fall within the protection scope of the present disclosure.

What is claimed is:

1. A neon pattern lamp with a multi-color dynamic lighting effect, wherein the neon pattern lamp comprises a bottom plate (1) and a neon lamp tube (2); the entire bottom plate (1) is tree-shaped; and the neon lamp tube (2) is arranged at an upper end of the bottom plate (1).

2. The neon pattern lamp with the multi-color dynamic lighting effect according to claim 1, wherein the neon lamp tube (2) has static lighting.

3. The neon pattern lamp with the multi-color dynamic lighting effect according to claim 1, wherein eye sheets (3) are arranged in a center of a surface of the bottom plate (1), and the eye sheets (3) are composed of white paper.

4. The neon pattern lamp with the multi-color dynamic lighting effect according to claim 3, wherein fixed strips (4) are arranged on side surfaces of the eye sheets (3); and lamp bodies (5) are arranged on side surfaces of the fixed strips (4) at equal distances.
